(19) United States
(12) Patent Application Publication
(10) Pub. No.: US 2017/0287031 A1
(43) Pub. Date: Oct. 5, 2017

(54) DATA PROCESSING AND COMMUNICATION SYSTEMS AND METHODS FOR OPERATIONALIZING PRIVACY COMPLIANCE AND REGULATION AND RELATED SYSTEMS AND METHODS

(71) Applicant: OneTrust, LLC, Atlanta, GA (US)

(72) Inventor: Kabir A. Barday, Atlanta, GA (US)

(21) Appl. No.: 15/619,237

(22) Filed: Jun. 9, 2017

Related U.S. Application Data
(63) Continuation-in-part of application No. 15/256,419, filed on Sep. 2, 2016, now Pat. No. 9,691,090.
Application No. 15/256,419 is a continuation of application No. 15/169,643, filed on May 31, 2016.
(60) Provisional application No. 62/317,457, filed on Apr. 1, 2016.
(60) Provisional application No. 62/360,123, filed on Jul. 8, 2016.
(60) Provisional application No. 62/353,802, filed on Jun. 23, 2016.
(60) Provisional application No. 62/348,695, filed on Jun. 10, 2016.

(51) Int. Cl. G06Q 30/06; G06Q 10/06

(52) U.S. Cl. CPC G06Q 30/0609; G06Q 10/063114

(57) ABSTRACT

A privacy compliance oversight system, according to particular embodiments, is configured to facilitate review and oversight of privacy campaign information by a third-party regulator. The system may implement this oversight by: (1) flagging a particular privacy campaign, project, or other activity for review by a third-party regulators; (2) in response to flagging the particular privacy campaign, project, or other activity for review, preparing campaign data associated with the particular privacy campaign, project, or other activity for review by the third-party regulator; (3) providing the third party regulator with access to the privacy campaign data; (4) receiving one or more pieces of feedback associated with the particular privacy campaign, project, or other activity from the third-party regulators; and (5) in response to receiving the one or more pieces of feedback, modifying the privacy campaign data to include the one or more pieces of feedback.

### CROSS-REFERENCE TO RELATED APPLICATIONS

This application is a continuation-in-part of U.S. patent application Ser. No. 15/256,419, filed Sep. 2, 2016, which is a continuation of U.S. patent application Ser. No. 15/169,643, filed May 31, 2016, which claims priority to U.S. Provisional Patent Application Ser. No. 62/317,457, filed Apr. 1, 2016, and this application also claims priority to U.S. Provisional Patent Application Ser. No. 62/360,123, filed Jul. 8, 2016; U.S. Provisional Patent Application Ser. No. 62/353,802, filed Jun. 23, 2016; and U.S. Provisional Patent Application Ser. No. 62/348,695, filed Jun. 10, 2016, the disclosures of which are hereby incorporated by reference in their entirety.

### TECHNICAL FIELD

This disclosure relates to, among other things, data processing systems and methods for retrieving data regarding a plurality of privacy campaigns, using that data to assess a relative risk associated with the data privacy campaign, providing an audit schedule for each campaign, providing partial or complete access to the system to one or more third party regulators to review the plurality of privacy campaigns and/or the system, and electronically display campaign information.

### BACKGROUND

Over the past years, privacy and security policies, and related operations have become increasingly important. Breaches in security, leading to the unauthorized access of personal data (which may include sensitive personal data) have become more frequent among companies and other organizations of all sizes. Such personal data may include, but is not limited to, personally identifiable information (PII), which may be information that directly (or indirectly) identifies an individual or entity. Examples of PII include names, addresses, dates of birth, social security numbers, and biometric identifiers such as a person's fingerprints or picture. Other personal data may include, for example, customers' Internet browsing habits, purchase history, or even their preferences (e.g., likes and dislikes, as provided or obtained through social media). While not all personal data may be sensitive, in the wrong hands, this kind of information may have a negative impact on the individuals or entities whose sensitive personal data is collected, including identity theft and embarrassment. Not only would this breach have the potential of exposing individuals to malicious wrongdoing, the fallout from such breaches may result in damage to reputation, potential liability, and costly remedial action for the organizations that collected the information and that were under an obligation to maintain its confidentiality and security. These breaches may result in not only financial loss, but loss of credibility, confidence, and trust from individuals, stakeholders, and the public.

Many organizations that obtain, use, and transfer personal data, including sensitive personal data, have begun to address these privacy and security issues. To manage personal data, many companies have attempted to implement operational policies and processes that comply with legal requirements, such as Canada's Personal Information Protection and Electronic Documents Act (PIPEDA) or the U.S.'s Health Insurance Portability and Accountability Act (HIPPA) protecting a patient's medical information. The European Union's General Data Protection Regulation (GDPR) can fine companies up to 4% of their global worldwide turnover (revenue) for not complying with its regulations (companies must comply by March 2018). These operational policies and processes also strive to comply with industry best practices (e.g., the Digital Advertising Alliance's Self-Regulatory Principles for Online Behavioral Advertising). Many regulators recommend conducting privacy impact assessments, or data protection risk assessments along with data inventory mapping. For example, the GDPR requires data protection impact assessments. Additionally, the United Kingdom ICO's office provides guidance around privacy impact assessments. The OPC in Canada recommends personal information inventory, and the Singapore PDPA specifically mentions personal data inventory mapping.

Thus, developing operational policies and processes may reassure not only regulators, but also an organization's customers, vendors, and other business partners.

For many companies handling personal data, privacy audits, whether done according to AICPA Generally Accepted Privacy Principles, or ISACA's IT Standards, Guidelines, and Tools and Techniques for Audit Assurance and Control Professionals, are not just a best practice, they are a requirement (for example, Facebook and Google will be required to perform 10 privacy audits each until 2032 to ensure that their treatment of personal data comports with the expectations of the Federal Trade Commission). When the time comes to perform a privacy audit, be it a compliance audit or adequacy audit, the lack of transparency or clarity into where personal data comes from, where is it stored, who is using it, where it has been transferred, and for what purpose is it being used, may bog down any privacy audit process. Even worse, after a breach occurs and is discovered, many organizations are unable to even identify a clear-cut organizational owner responsible for the breach recovery, or provide sufficient evidence that privacy policies and regulations were complied with.

In light of the above, there is currently a need for improved systems and methods for monitoring compliance with corporate privacy policies and applicable privacy laws.

### SUMMARY

According to various embodiments, a computer-implemented data processing method for facilitating third-party regulatory oversight of a privacy compliance system associated with an organization, comprises: (1) flagging, by one or more processors, a particular project undertaken by the organization that includes the use of personal data for review, wherein the privacy compliance system digitally stores an electronic record associated with the particular project. In various embodiments, the electronic record comprises: (i) one or more types of personal data related to the project; (ii) a subject from which the personal data was collected; (iii) a storage location of the personal data; and (iv) one or more access permissions associated with the personal data. In particular embodiments, the method further comprises: (1) in response to flagging the particular project, preparing, by one or more processors, the electronic record for review by a third-party regulator; (2) providing, by one or more processors, the third-party regulator with access to the electronic record; (3) receiving, from the third-party regulator, by one or more processors, one or more pieces of feedback associated with the project; and (4) in response to receiving the one or more pieces of feedback, modifying, by one or more processors, the electronic record to include the one or more pieces of feedback.

A computer-implemented data processing method for electronically performing third-party oversight of one or more privacy assessments of computer code, in various embodiments, comprises: (1) flagging the computer code for third-party oversight, the computer code being stored in a location; (2) electronically obtaining the computer code based on the location provided; (3) automatically electronically analyzing the computer code to determine one or more privacy-related attributes of the computer code, each of the privacy-related attributes indicating one or more types of personal information that the computer code collects or accesses; (4) generating a list of the one or more privacy-related attributes; (5) transmitting the list of the one or more privacy-related attributes to a computing device associated with a third-party regulator; (6) electronically displaying one or more prompts to the third-party regulator, each prompt informing the third-party regulator to input information regarding one or more of the one or more privacy-related attributes; and (7) communicating the information regarding the one or more privacy-related attributes to one or more second individuals for use in conducting a privacy assessment of the computer code.

### BRIEF DESCRIPTION OF THE DRAWINGS

Various embodiments of a system and method for privacy compliance oversight are described below. In the course of this description, reference will be made to the accompanying drawings, which are not necessarily drawn to scale, and wherein:

FIG. 1 depicts a privacy compliance oversight system according to particular embodiments.

FIG. 2 is a schematic diagram of a computer (such as the privacy compliance oversight server 100, or one or more remote computing devices 130) that is suitable for use in various embodiments of the privacy compliance oversight system shown in FIG. 1.

FIGS. 3A-3B depict a flow chart showing an example of a processes performed by the Privacy Compliance Oversight Module according to particular embodiments.

FIGS. 4-10 depict exemplary screen displays and graphical user interfaces (GUIs) according to various embodiments of the system, which may display information associated with the system or enable access to or interaction with the system by one or more users.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Overview

A privacy compliance oversight system, according to particular embodiments, is configured to facilitate review and oversight of privacy campaign information by a third-party regulator. In various embodiments, a privacy campaign may include any undertaking by a particular organization (e.g., such as a project or other activity) that includes the collection, entry, and/or storage (e.g., in memory) of any privacy information or personal data associated with one or more individuals. In other embodiments, a privacy campaign may include any project undertaken by an organization that includes the use of personal data, or to any other activity which could have an impact on the privacy of one or more individuals. This personal data may include, for example, for an individual: (1) name; (2) address; (3) telephone number; (4) e-mail address; (5) social security number; (6) information associated with one or more credit accounts (e.g., credit card numbers); (7) banking information; (8) location data; (9) internet search history; (10) account data; and (11) any other suitable personal information discussed herein.

As generally discussed above, a particular organization may be required to implement operational policies and processes to comply with one or more legal requirements in handling such personal data. A particular organization may further take steps to comply with one or more industry best practices. In particular embodiments, these operational policies and processes may include, for example: (1) storing personal data in a suitable location; (2) limiting access to the personal data to only suitable individuals or entities within the origination or external to the organization; (3) limiting a length of time for which the data will be stored; and (4) any other suitable policy to ensure compliance with any legal or industry guidelines. In particular embodiments, the legal or industry guidelines may vary based at least in part on, for example: (1) the type of data being stored; (2) an amount of data; (3) whether the data is encrypted; (4) etc.

In particular embodiments, the privacy compliance oversight system may be configured to facilitate oversight by one or more third-party regulators of a particular organization's privacy compliance system. In various embodiments, the one or more third-party regulators may include, for example, one or more auditors, one or more government officials, or any other third-party regulator. In particular embodiments, the one or more third-party regulators may include any suitable third-party regulator that has no affiliation with the organization associated with the privacy campaign or privacy compliance system being reviewed. In particular embodiments, the privacy compliance oversight system is configured to, for example, allow the one or more third-party regulators to review privacy campaign information directly within a particular instance of a privacy compliance system and, in some embodiments, approve a particular privacy campaign electronically. In such embodiments, the system may be configured to provide access, to the third-party regulator, to at least a portion of the organization's privacy compliance system. For example, the privacy compliance oversight system may enable the third-party regulator to access and review a particular privacy campaign for compliance without providing access to the organization's entire privacy compliance system.

For example, a particular organization's privacy compliance system may store information related to a plurality of privacy campaigns that the particular organization has undertaken. Each particular privacy campaign may include the receipt or entry and subsequent storage of personal data associated with one or more individuals as part of the privacy campaign. An exemplary privacy campaign, may, for example, include the collection and storage of the organization's employees' names, contact information, banking information, and social security numbers for use by the organization's accounting department for payroll purposes.

In various embodiments, the system may implement this concept by: (1) flagging a particular privacy campaign, project, or other activity for review by a third-party regulator (e.g., which may include any suitable way for demarking a particular privacy campaign as needing regulatory review); (2) in response to flagging the particular privacy campaign, project, or other activity for review, preparing campaign data associated with the particular privacy campaign, project, or other activity for review by the third-party regulator (e.g., by modifying the campaign data, translating the campaign data between one or more human languages, etc.); (3) providing the third party regulator with access to the privacy campaign data; (4) receiving one or more pieces of feedback associated with the particular privacy campaign, project, or other activity from the third-party regulators; and (5) in response to receiving the one or more pieces of feedback, modifying the privacy campaign data to include the one or more pieces of feedback. In particular embodiments, the system may further generate a checklist of actions taken by the third-party regulator and store the checklist in memory for review by the organization. Various embodiments of a system for providing oversight of a privacy compliance system by a third-party regulator are further described below.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

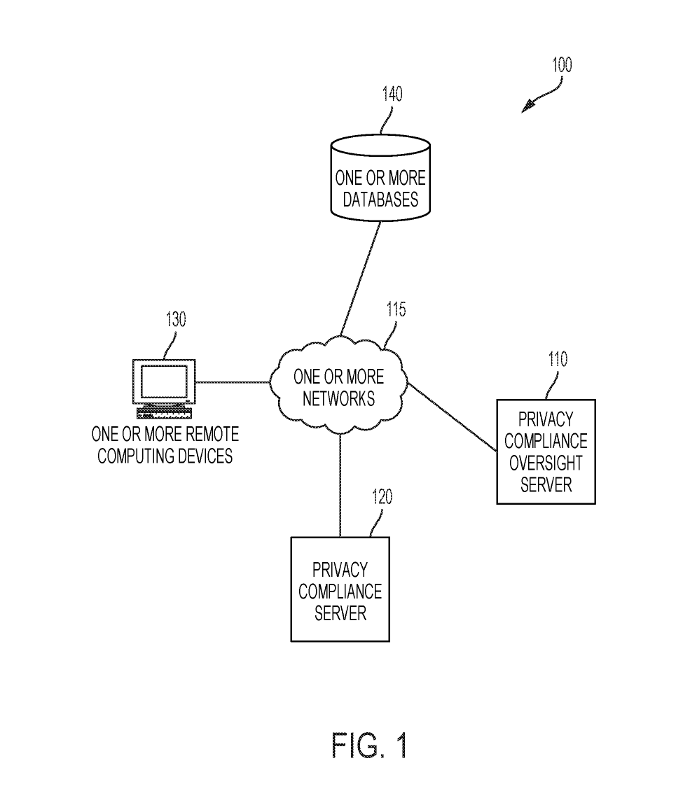

FIG. 1 is a block diagram of a Privacy Compliance Oversight System 100 according to a particular embodiment. In various embodiments, the Privacy Compliance Oversight System 100 is part of a Privacy Compliance System, or a plurality of Privacy Compliance Systems, which may each be associated with a respective particular organization. In various embodiments, each particular Privacy Compliance System may be associated with a respective particular organization and be configured to manage one or more privacy campaigns, projects, or other activities associated with the particular organization. In some embodiments, the Privacy Compliance Oversight System 100 is configured to interface with at least a portion each respective organization's Privacy Compliance System in order to facilitate oversight review of the system to ensure compliance with prevailing legal and industry requirements for collecting, storing, and processing personal and other data.

As may be understood from FIG. 1, the Privacy Compliance Oversight System 100 includes one or more computer networks 115, a Privacy Compliance Oversight Server 110, a Privacy Compliance Server 120, one or more remote computing devices 130 (e.g., a desktop computer, laptop computer, tablet computer, etc.), and One or More Databases 140. In particular embodiments, the one or more computer networks 115 facilitate communication between the Privacy Compliance Oversight Server 100, Privacy Compliance Server 120, one or more remote computing devices 130 (e.g., a desktop computer, laptop computer, tablet computer, etc.), and one or more databases 140.

The one or more computer networks 115 may include any of a variety of types of wired or wireless computer networks such as the Internet, a private intranet, a public switch telephone network (PSTN), or any other type of network. The communication link between Privacy Compliance Oversight Server 100 and Database 140 may be, for example, implemented via a Local Area Network (LAN) or via the Internet.

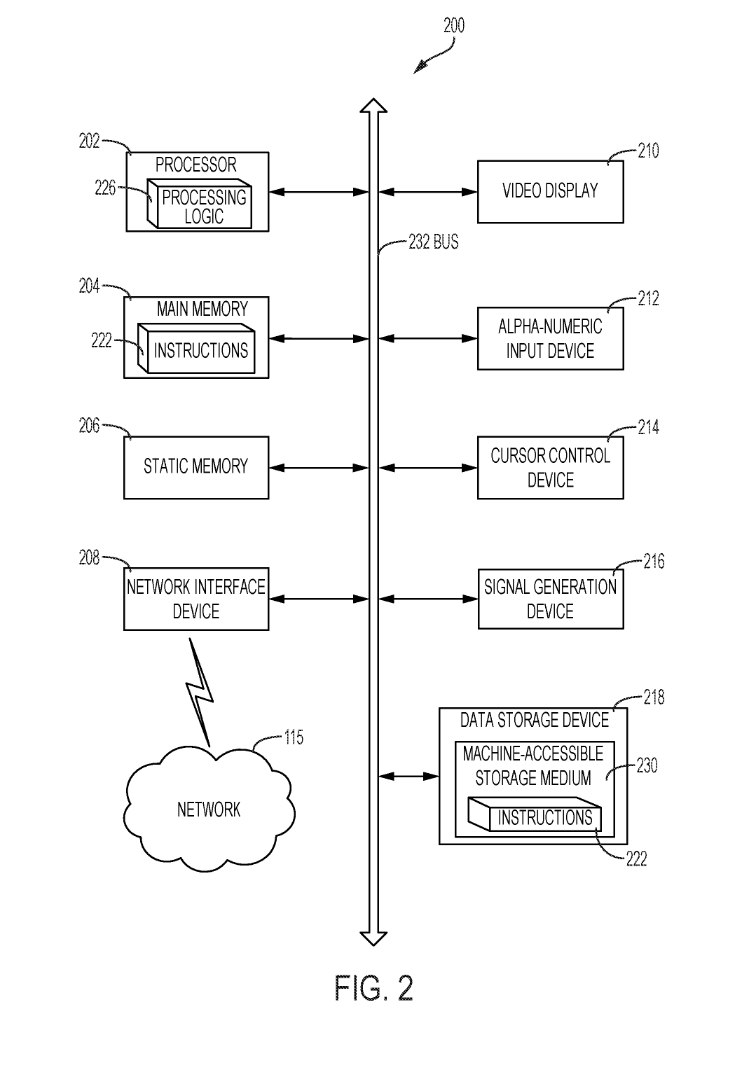

FIG. 2 illustrates a diagrammatic representation of a computer 200 that can be used within the Privacy Compliance Oversight System 110, for example, as a client computer (e.g., one or more remote computing devices 130 shown in FIG. 1), or as a server computer (e.g., Privacy Compliance Oversight Server 110 shown in FIG. 1). In particular embodiments, the computer 200 may be suitable for use as a computer within the context of the Privacy Compliance Oversight System 110 that is configured to facilitate oversight of one or more privacy campaigns.

In particular embodiments, the computer 200 may be connected (e.g., networked) to other computers in a LAN, an intranet, an extranet, and/or the Internet. As noted above, the computer 200 may operate in the capacity of a server or a client computer in a client-server network environment, or as a peer computer in a peer-to-peer (or distributed) network environment. The Computer 200 may be a personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 200 includes a processing device 202, a main memory 204 (e.g., read-only memory (ROM), flash memory, dynamic random access memory (DRAM) such as synchronous DRAM (SDRAM) or Rambus DRAM (RDRAM), etc.), static memory 206 (e.g., flash memory, static random access memory (SRAM), etc.), and a data storage device 218, which communicate with each other via a bus 232.

The processing device 202 represents one or more general-purpose processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 120 may further include a network interface device 208. The computer 200 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-accessible storage medium 230 (also known as a non-transitory computer-readable storage medium or a non-transitory computer-readable medium) on which is stored one or more sets of instructions (e.g., software instructions 222) embodying any one or more of the methodologies or functions described herein. The software instructions 222 may also reside, completely or at least partially, within main memory 204 and/or within processing device 202 during execution thereof by computer 200—main memory 204 and processing device 202 also constituting computer-accessible storage media. The software instructions 222 may further be transmitted or received over a network 115 via network interface device 208.

While the computer-accessible storage medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium that is capable of storing, encoding or carrying a set of instructions for execution by the computer and that cause the computer to perform any one or more of the methodologies of the present invention. The term “computer-accessible storage medium” should accordingly be understood to include, but not be limited to, solid-state memories, optical and magnetic media, etc.

### Exemplary System Platform

Various embodiments of a privacy compliance oversight system may be implemented in the context of any suitable privacy compliance system. For example, the privacy compliance oversight system may be implemented to review privacy impact assessments and other initiatives related to the collection and storage of personal data. Various aspects of the system's functionality may be executed by certain system modules, including a Privacy Compliance Oversight Module 300. This module is discussed in greater detail below. Although the Privacy Compliance Oversight Module 300 is presented as a series of steps, it should be understood in light of this disclosure that various embodiments of the Privacy Compliance Oversight Module may perform the steps described below in an order other than in which they are presented. In still other embodiments, the Privacy Compliance Oversight Module may omit certain steps described below. In still other embodiments, the Privacy Compliance Oversight Module may perform steps in addition to those described.

### Privacy Compliance Oversight Module

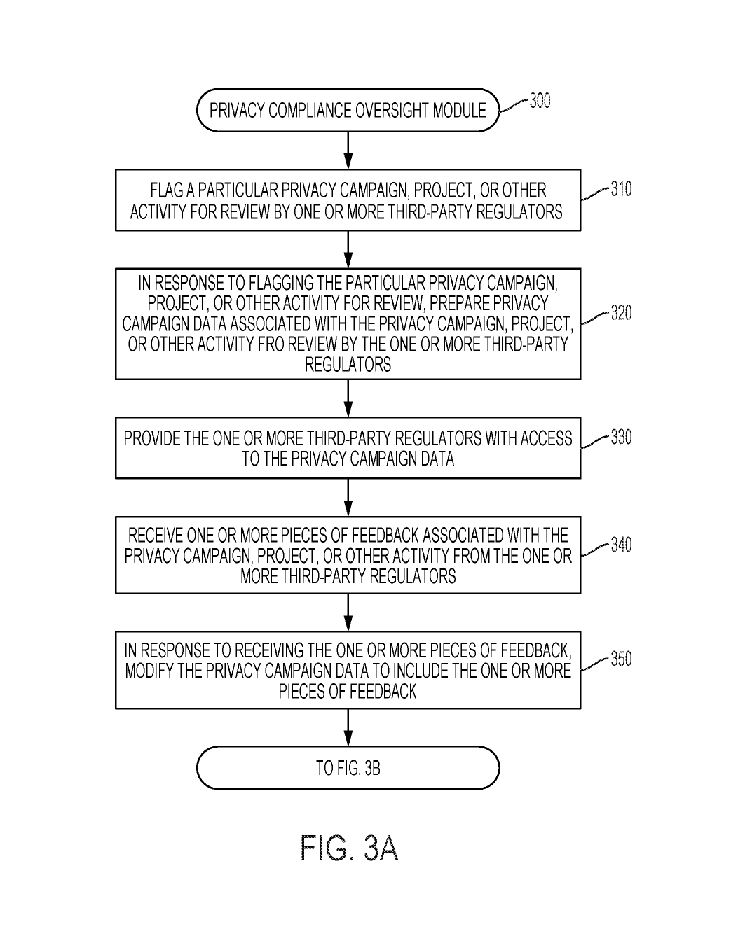

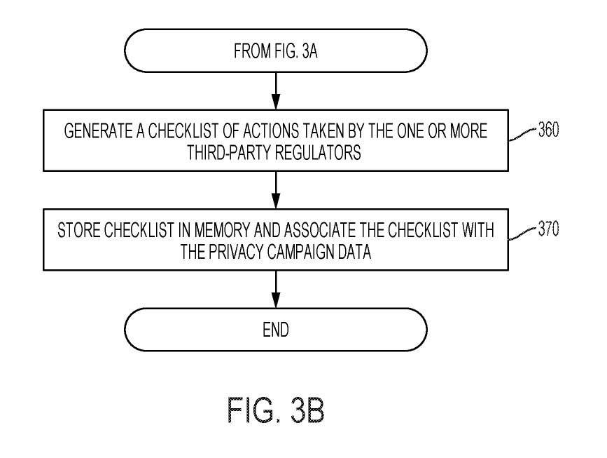

Turning to FIG. 3A, in particular embodiments, when executing the Privacy Compliance Oversight Module 300, the system begins, at Step 310, by flagging a particular privacy campaign, project, or other activity for review by one or more third-party regulators.

In various embodiments, the system is configured to substantially automatically flag the particular privacy campaign, project, or other activity for review. In such embodiments, the system may, for example, substantially automatically (e.g., automatically) flag the particular privacy campaign, project, or other activity for review in response to initiation of the privacy campaign, project, or other activity. In other embodiments, the system is configured to substantially automatically flag the particular privacy campaign, project, or other activity for review in response to a revision or modification to an existing particular privacy campaign, project, or other activity.

In still other embodiments, the system is configured to substantially automatically flag a particular privacy campaign, project, or other activity for review according to a particular schedule (e.g., annually, every certain number of years, or according to any other suitable review schedule). In particular embodiments, the system is configured to flag the particular privacy campaign, project, or other activity for review based at least in part on a type of the particular privacy campaign, project, or other activity. For example, the system may specifically flag changes to storage of data, implementation of new privacy campaigns, or other activities for review. In still other embodiments, the system may be configured to flag a particular privacy campaign, project, or other activity for review that is of any suitable type described herein.

In various embodiments, the system is configured to substantially automatically flag the particular privacy campaign, project, or other activity for review based at least in part on a type of personal data collected and stored during the particular privacy campaign, project, or other activity. For example, particular personal data may require oversight by a third-party regulator (e.g., by law or according to one or more industry standards). Such personal data may include more sensitive personal data such as personal identifiers, banking information, browsing cookies, etc. The system may be configured to automatically flag a privacy campaign that includes the collection of such data.

In particular embodiments, the system is configured to flag a particular privacy campaign, project, or other activities for review in response to receiving, from an individual associated with the particular organization, a request for one or more third-party regulators to review the organization's privacy compliance system (e.g., or a particular privacy campaign, project, or other activity that makes up at least a part of the organization's privacy compliance system).

In various embodiments, the system is configured to flag activities for review at varying levels of expediency. For example, in particular embodiments, the system is configured to enable the individual associated with the organization to request to flag a particular privacy campaign, project, or other activity for review in an expedited manner. In such embodiments, the system may be configured to limit a number of expedited reviews to which a particular organization is entitled (e.g., within a predetermined period of time such as during a calendar year). In particular embodiments, the system is configured to expedite review by facilitating the review out of turn of one or more other requests to review a particular privacy campaign, or out of turn of any other privacy campaign flagged for review (e.g., the privacy campaign under expedited review may jump the queue of one or more other pending reviews). As may be understood in light of this disclosure, particular privacy campaigns, projects, or other activities may require approval from a regulating authority before being implemented by an organization. Because a high demand for review may result in delay of requested reviews by the regulating authority, it may be advantageous for an organization to utilize expedited review for particular privacy campaigns, projects, or other activities that the organization is seeking to deploy more rapidly. Less important or less pressing activities may not require such expedited approval. In such cases, the organization may request review by the third-party regulator without expediting the request.

In various embodiments, the privacy campaign may be associated with an electronic record (e.g., or any suitable data structure) comprising privacy campaign data. In particular embodiments, the privacy campaign data comprises a description of the privacy campaign, one or more types of personal data related to the campaign, a subject from which the personal data is collected as part of the privacy campaign, a storage location of the personal data (e.g., including a physical location of physical memory on which the personal data is stored), one or more access permissions associated with the personal data, and/or any other suitable data associated with the privacy campaign.

An exemplary privacy campaign, project, or other activity may include, for example: (1) a new IT system for storing and accessing personal data (e.g., include new hardware and/or software that makes up the new IT system; (2) a data sharing initiative where two or more organizations seek to pool or link one or more sets of personal data; (3) a proposal to identify people in a particular group or demographic and initiate a course of action; (4) using existing data for a new and unexpected or more intrusive purpose; and/or (5) one or more new databases which consolidate information held by separate parts of the organization. In still other embodiments, the particular privacy campaign, project or other activity may include any other privacy campaign, project, or other activity discussed herein, or any other suitable privacy campaign, project, or activity.

Returning to FIG. 3A and continuing to Step 320, the system, in response to flagging the particular privacy campaign, project, or other activity for review, prepares the privacy campaign data associated with the privacy campaign, project, or other activity for review by the one or more third-party regulators. In various embodiments, preparing the privacy campaign data for review comprises preparing the organization's privacy system for review by the one or more third-party regulators. In various embodiments, preparing the organization's privacy system for review comprises preparing data associated with the particular privacy campaign, project, or other activity for review by the one or more third-party regulators. The system may, for example, export relevant data associated with the particular privacy campaign, project, or other activity into a standardized format. In particular embodiments, the system is configured to code the relevant data to a format provided by the one or more third-party regulators.

In other embodiments, the system exports the relevant data into a format selected by the organization. In particular embodiments, the system is configured to export only data that is relevant to the review by the one or more third-party regulators (e.g., as opposed to an entire electronic record associated with the privacy campaign). In various embodiments, exporting the privacy campaign data comprises modifying the electronic record into a format other than a format in which it is stored as part of the organization's privacy compliance system. In such embodiments, exporting the privacy campaign data may enable the one or more third-party regulators to review the privacy campaign data without accessing (e.g., logging into or otherwise viewing) the organization's privacy compliance system.

For example, although an organization's privacy compliance system may store personal and other data associated with a plurality of privacy campaigns, projects, and other activities, the system may, when exporting relevant data for review, limit the exported data to data associated with the particular privacy campaign, project, or other activity under review. In this way, in various embodiments, the system may conserve computing resources by limiting an amount of data that the system is required to transfer from the privacy compliance system to an external privacy compliance review system (e.g., or other location) for review by the third-party regulator. In particular embodiments, exporting the data may include exporting the data into any suitable format such as, for example Word, PDF, spreadsheet, CSV file, etc.

In particular embodiments, preparing the organization's privacy system for review by the one or more third-party regulators comprises generating a limited-access account for use by the one or more third-party regulators when accessing the privacy system. In various embodiments, the limited-access account enables access to at least a portion of the organization's privacy system and restricts and/or limits access to the overall system to the particular privacy campaign, project, or other activity that needs to be reviewed. For example, in such embodiments, the limited-access account may limit access to all data, comments, audit logs, and other information associated with the particular privacy campaign, project, or other activity that needs to be reviewed but not enable access to any other unrelated privacy campaigns, projects, or activities that are not currently flagged for review. In various embodiments, the system is configured to generate and/or manage a limited-access account by modifying one or more access permissions associated with the account.

In such embodiments, the one or more third-party regulators, when accessing the organization's privacy compliance system, may see a limited version of the organization's complete system. In particular embodiments, the system may generate a secure link for transmission to the one or more third-party regulators as part of preparation for the review. The secure link may, for example, provide limited access to the organization's privacy system (e.g., via one or more suitable graphical user interfaces).

In various embodiments, as may be understood in light of this disclosure, legal requirements may vary for privacy campaigns in various countries. As such, in particular embodiments, one or more third-party regulators may speak one or more languages other than a language in which a particular organization has implemented its privacy campaigns, projects, and other activities. In other embodiments, a particular organization may collect personal data for a particular privacy campaign in a plurality of different languages. Particular organizations that collect information from individuals from a variety of countries as part of a particular privacy campaign may potentially, for example, collect data in a plurality of different languages

In embodiments such as those described herein, the system, when preparing the organization's privacy data for review, may be configured to substantially automatically translate all data associated with the privacy campaign into a single language as necessary (e.g., translate the data into a single human language such as English). In such embodiments, the system is configured to translate the data from a first language to a second language using one or more machine translation techniques. The system may be further configured to translate the data based at least in part on a language spoken (e.g., or read) by the one or more third-part regulators.

Returning to Step 330, the system, in various embodiments, provides the one or more third-party regulators with access to data associated with the privacy campaign, project, or other activity for review (e.g., the privacy campaign data). In various embodiments, the system is configured to transmit the exported data associated with the particular privacy campaign, project, or other activity to the one or more third-party regulators (e.g., via one or more networks). In various embodiments, the system is configured to transmit the formatted data in any suitable manner (e.g., via a suitable messaging application, or in any suitable secure manner).

In various embodiments, the system is configured to generate a secure link via which the one or more third-party regulators can access at least a portion of the organization's privacy compliance system. In various embodiments, the system then provides access to the at least a portion of the organization's privacy compliance system via the secure link. In particular embodiments, the at least a portion of the organization's privacy compliance system comprises a portion of the organization's privacy compliance system related to the privacy campaign, project, or other activity under review. In various embodiments, the at least a portion of the organization's privacy compliance system is the portion of the organization's privacy compliance system described above in relation to the limited-access account.

In various embodiments, the system provides the third-party regulator with access to data associated with the privacy campaign, project, or other activity for review by displaying, on a graphical user interface, data related to the privacy campaign, project, or other activity to the one or more third-party regulators. In such embodiments, the system may display the second instance of the privacy compliance system to the one or more third-party regulators via the GUI. GUIs related to the display of a privacy compliance system for review by a third party regulator according to particular embodiments are described more fully below under the heading Exemplary User Experience.

Continuing to Step 340, the system receives one or more pieces of feedback associated with the campaign from the one or more third-party regulators. The system may, for example, provide one or more prompts on the GUI with which the one or more third-party regulators may provide the one or more pieces of feedback. In particular embodiments, the system may, for example, provide one or more prompts for each of the one or more types of personal data related to the privacy campaign, project, or other activity. In various embodiments, the system is configured to receive the one or more pieces of feedback in response to input, by the one or more third-party-regulators, via the one or more prompts.

In various other embodiments, the system is configured to receive the one or more pieces of feedback in response to an approval of a particular aspect of the privacy campaign, project, or other activity by the one or more third-party regulators. In various embodiments, the system is configured to receive the approval via selection, by the one or more third-party-regulators of an indicia associated with the particular aspect of the privacy campaign. The one or more third-party-regulators may, for example, indicate approval of a manner in which a particular type of personal data is stored as part of the privacy campaign (e.g., indicate that the manner in which the data is stored conforms to a particular legal or industry standard). In various embodiments, ‘approval’ by the third-party regulator may indicate that the particular aspect of the privacy campaign that is ‘approved’ meets or exceeds any legal or industry standard related to that particular aspect (e.g., the data storage location is sufficiently secure, a sufficient level of encryption is applied to the data, access to the data is limited to entities which are legally entitled to view it, etc.).

In particular other embodiments, the one or more pieces of feedback may include feedback related to the privacy campaign exceeding a particular legal or industry standard. In such embodiments, such feedback may enable a particular organization to reduce particular storage and data security steps taken with particular campaign data for which it is not required. In various embodiments, by modifying data storage techniques as part of a particular privacy campaign to meet but not exceed a particular legal or industry standard, the system may be configured to conserve computing resources required to implement higher encryption levels for data storage. In other embodiments, by modifying data storage techniques as part of a particular privacy campaign to meet but not exceed a particular legal or industry standard, the system is configured to: (1) limit redundancy of stored data (e.g., which may conserve memory); (2) eliminate unnecessary data permission limitations; and/or (3) take any other action which may limit privacy campaign data recall times, storage size, transfer time, etc.

Advancing to Step 350, the system, in response to receiving the one or more pieces of feedback, associates the feedback, in memory, with the privacy campaign. In various embodiments, the system is configured to associate the one or more pieces of feedback with the privacy campaign (e.g., or the project or other activity) by electronically associating the one or more pieces of feedback with particular respective aspects of the privacy campaign data. In particular embodiments, the system is configured to modify the campaign data to include the one or more pieces of feedback. In such embodiments, the system may be configured to modify underlying campaign data to include the one or more pieces of feedback such that the system presents a subsequent user (e.g., individual associated with the organization) accessing the organization's privacy compliance system with the one or more pieces of feedback as part of the campaign data.

In particular embodiments, the system optionally continues, at Step 360, by generating a checklist of actions taken by the one or more third-party regulators while accessing the at least a portion of the privacy compliance system in order to review the privacy campaign, project, or other activity for compliance. In various embodiments, the system is configured to generate a checklist that includes a list of all of the one or more pieces of feedback provided by the one or more third-party retailers during the review process. In other embodiments, the checklist may include a list of action items for review by the organization in order to modify the particular privacy campaign so that it complies with prevailing legal and industry standards.

In some embodiments, the systems continues at Step 370 by associating the generated checklist with the campaign data in memory for later retrieval. In particular embodiments, associating the generated checklist with the campaign data may include modifying the campaign data to include the checklist.

### Exemplary User Experience

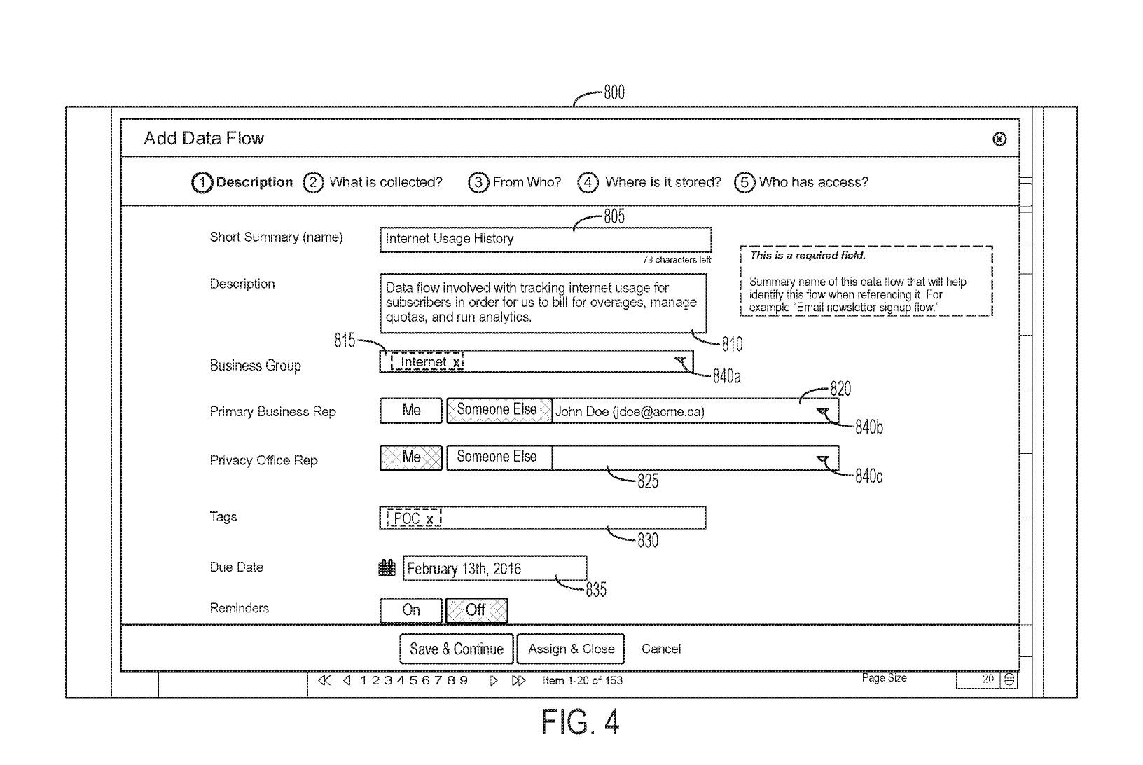

In exemplary embodiments of a privacy compliance oversight system, a third-party regulator may experience a limited version of a privacy compliance system. For example, the third-party regulator may access, via one or more graphical user interfaces, a portion of an overall privacy compliance system that includes particular access to information and other data associated with one or more privacy campaigns that the third-party regulator is tasked for reviewing. FIGS. 4-12 depict exemplary screen displays of a privacy compliance system and a privacy compliance oversight system according to particular embodiments. As may be understood from these figures in light of this disclosure, a privacy compliance system may provide access to the privacy compliance system (e.g., to an individual associated with an organization) via one or more GUIs with which the individual may initiate a new privacy campaign, project, or other activity or to modify an existing one.

The one or more GUIs may enable the individual to, for example, provide information such as: (1) a description of the campaign; (2) the personal data to be collected as part of the campaign; (3) who the personal data relates to; (4) where the personal data be stored; and (5) who will have access to the indicated personal data. Various embodiments of a system for implementing and auditing a privacy campaign are described in U.S. patent application Ser. No. 15/169,643, filed May 31, 2016 entitled “Data Processing Systems and Methods for Operationalizing Privacy Compliance and Assessing the Risk of Various Respective Privacy Campaigns”, which is hereby incorporated herein in its entirety. In particular embodiments, the system is further configured to provide access to a privacy compliance oversight system via one or more GUIs that enable the third-party regulator to review the information submitted by the individual as part of a privacy campaign, project, or other activity for compliance with one or more regulations. These exemplary screen displays and user experiences according to particular embodiments are described more fully below.

A. FIG. 4: Initiating a New Privacy Campaign, Project, or Other Activity

FIG. 4 illustrates an exemplary screen display with which a user associated with an organization may initiate a new privacy campaign, project, or other activity. As shown in FIG. 4, a description entry dialog 800 may have several fillable/editable fields and/or drop-down selectors. In this example, the user may fill out the name of the campaign (e.g., project or activity) in the Short Summary (name) field 805, and a description of the campaign in the Description field 810. The user may enter or select the name of the business group (or groups) that will be accessing personal data for the campaign in the Business Group field 815. The user may select the primary business representative responsible for the campaign (i.e., the campaign's owner), and designate him/herself, or designate someone else to be that owner by entering that selection through the Someone Else field 820. Similarly, the user may designate him/herself as the privacy office representative owner for the campaign, or select someone else from the second Someone Else field 825.

At any point, a user assigned as the owner may also assign others the task of selecting or answering any question related to the campaign. The user may also enter one or more tag words associated with the campaign in the Tags field 830. After entry, the tag words may be used to search for campaigns, or used to filter for campaigns (for example, under Filters 845). The user may assign a due date for completing the campaign entry, and turn reminders for the campaign on or off. The user may save and continue, or assign and close.

In example embodiments, some of the fields may be filled in by a user, with suggest-as-you-type display of possible field entries (e.g., Business Group field 815), and/or may include the ability for the user to select items from a drop-down selector (e.g., drop-down selectors 840a, 840b, 840c). The system may also allow some fields to stay hidden or unmodifiable to certain designated viewers or categories of users. For example, the purpose behind a campaign may be hidden from anyone who is not the chief privacy officer of the company, or the retention schedule may be configured so that it cannot be modified by anyone outside of the organization's' legal department.

In other embodiments, the system may be configured to grey-out or otherwise obscure certain aspects of the privacy campaign data when displaying it to particular users. This may occur, for example, during a third-party regulator review as discussed herein. The system may, for example, grey-out, or otherwise obscure various pieces of information that make up part of the privacy campaign but that are unrelated to the third-party regulator's oversight (e.g., information about which Business Group 815 may access data within the organization may not be relevant to a third-party regulator review to ensure that data is stored in a location that is in line with prevailing legal or industry standards in a particular instance).

In various embodiments, when initiating a new privacy campaign, project, or other activity (e.g., or modifying an existing one), the user associated with the organization may set a Due Date 835 that corresponds to a date by which the privacy campaign needs to be approved by a third-party regulator (e.g., such that the campaign may be approved prior to launching the campaign externally and/or beginning to collect data as part of the campaign). In various embodiments, the system may limit the proximity of a requested Due Date 835 to a current date based on a current availability of third-party regulators and/or whether the user has requested expedited review of the particular privacy campaign.

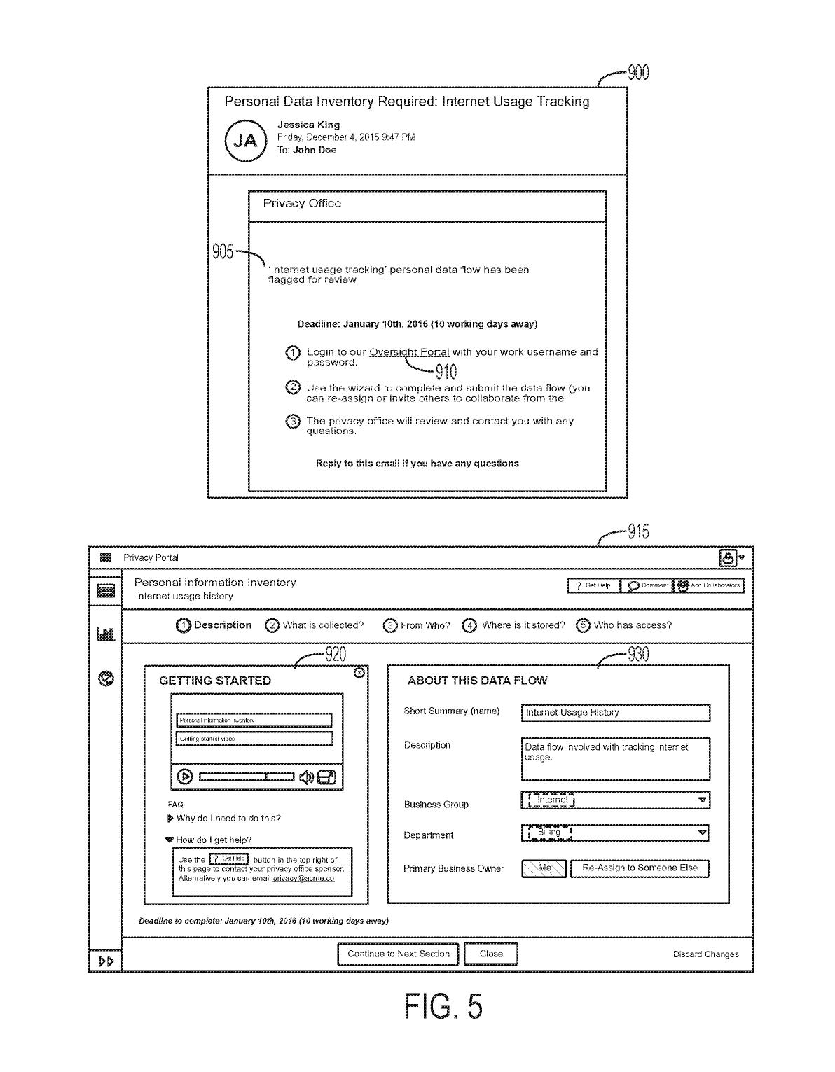

B. FIG. 5: Notification to Third-Party Regulator That Campaign has Been Flagged for Review

Moving to FIG. 5, in example embodiments, once a new privacy campaign has been initiated (e.g., or another action has been taken that flags a particular privacy campaign for review), the system transmits a notification to a third-party regulator that the privacy campaign has been flagged for review. FIG. 5 shows an example notification 900 sent to John Doe that is in the form of an email message with a secure link to login to a Privacy Oversight Portal 910. The email informs him that the campaign “Internet Usage Tracking” has been assigned to him for review, and provides other relevant information, including the deadline for completing the campaign entry and instructions to log in to the system to provide any applicable feedback related to the campaign's compliance with one or more legal or industry standards or practices (which may be done, for example, using a suitable “wizard” program). Also included may be an option to reply to the email if an assigned owner has any questions.

In this example, if John selects the hyperlink “Oversight Portal” 910, he may be able to access a limited version of the privacy compliance system (e.g., a privacy compliance oversight system), which displays a landing page 915. The landing page 915 displays a Getting Started section 920 to familiarize new owners with the system, and also displays an “About This Data Flow” section 930 showing overview information for the campaign. As may be understood from this figure in light of this disclosure, the landing page 915 may be substantially similar to (e.g., the same as) a landing page that a user of the privacy compliance system that is not a regulator performing oversight may see, for example, when the user is reviewing information about the privacy campaign internally within the organization, making one or more changes to the privacy campaign. The landing page 915 that the system presents the third-party regulator, however, may limit at least some system functionality (e.g., may limit permissions associated with the regulator's account within the system) to, for example, reviewing existing information, providing comments, etc. (e.g., the third-party regulator may be unable to make permanent changes to system entries). In particular embodiments, the third-party regulator may be accessing the privacy compliance system using a limited-access account (e.g., such as discussed above). In a particular embodiment, the limited-access account may be associated with one or more permissions that limit functionality of the system available to a user accessing the system using the account.

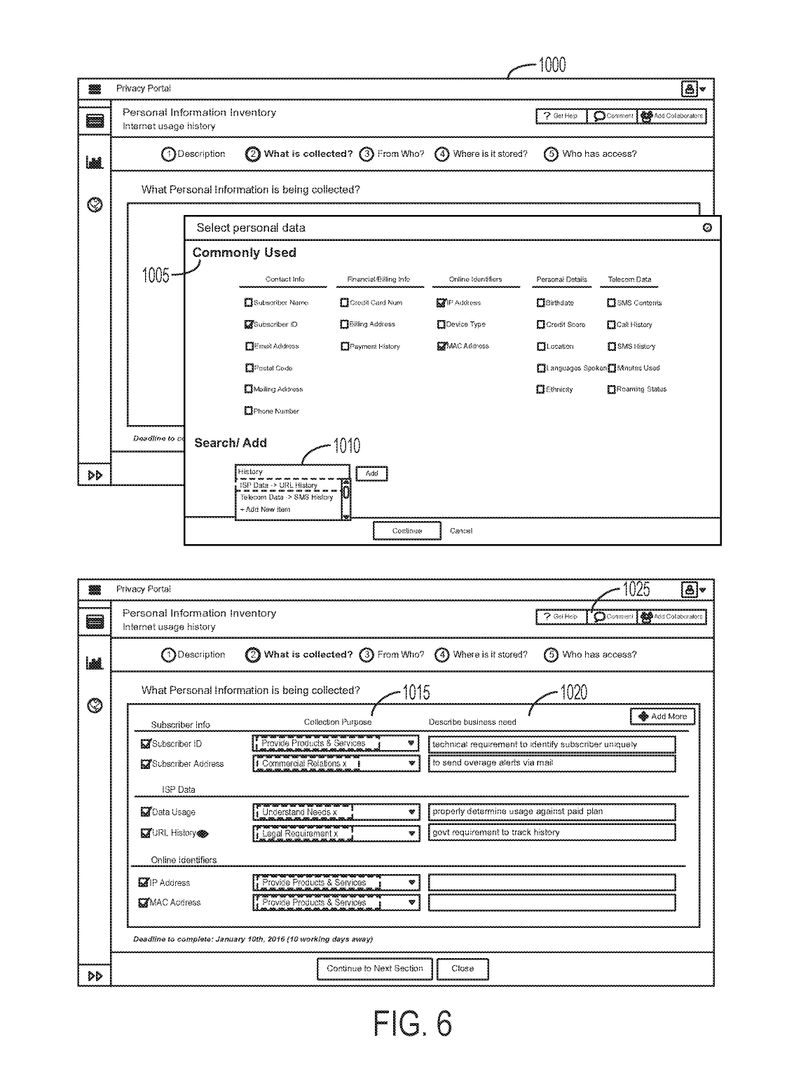

C. FIG. 6: What Personal Data is Collected

FIG. 6 depicts an exemplary screen display that shows a type of personal data that is collected as part of a particular campaign, in addition to a purpose of collecting such data, and a business need associated with the collection. As described in this disclosure, different types of users may experience different functionality within the privacy compliance system when accessing it via a suitable GUI. For example, regulators may experience a limited version of the overall system that limits their access to particular limitations (e.g., because they are accessing the system using an account with fewer permissions), limits their permissions with respect to making changes to existing data, etc. For the purpose of illustration, FIG. 6 and the subsequent figures will be described in the context of a user experience of both a user associated with the organization (e.g., who may be initiating a privacy campaign, or making one or more changes to an existing privacy campaign) and a third party regulator.

### i. Organization User Experience

As shown in FIG. 6, after the first phase of campaign addition (i.e., description entry phase), the system may present the user (who may be a subsequently assigned business representative or privacy officer associated with the organization) with a dialog 1000 from which the user may enter in the type of personal data being collected.

For example, in FIG. 6, the user may select from Commonly Used 1005 selections of personal data that will be collected as part of the privacy campaign. This may include, for example, particular elements of an individual's contact information (e.g., name, address, email address), Financial/Billing Information (e.g., credit card number, billing address, bank account number), Online Identifiers (e.g., IP Address, device type, MAC Address), Personal Details (Birthdate, Credit Score, Location), or Telecommunication Data (e.g., Call History, SMS History, Roaming Status). The System 100 is also operable to pre-select or automatically populate choices—for example, with commonly-used selections 1005, some of the boxes may already be checked. The user may also use a search/add tool 1010 to search for other selections that are not commonly used and add another selection. Based on the selections made, the system may present the user with more options and fields. For example, in response to the user selecting “Subscriber ID” as personal data associated with the campaign, the user may be prompted to add a collection purpose under the heading Collection Purpose 1015, and the user may be prompted to provide the business reason why a Subscriber ID is being collected under the “Describe Business Need” heading 1020.

### i. Third-Party Regulator Experience

When reviewing a privacy campaign for compliance with one or more legal or industry standards, the system may enable the third-party regulator to review the types of personal data collected as part of the privacy campaign using the screen displays shown in FIG. 6. As may be understood in light of this disclosure, while the third-party regulator is accessing the system in an oversight capacity, the regulator may be unable to make changes to the campaign data (e.g., by selecting additional data collected, changing entered collection purpose, etc.). The third party regulator may, however, be able to add one or more comments by selecting a comments 1025 indicia.

In response to entry of one or more comments by the regulator, the system may associate the entered comments with the personal data in memory such that an organization user subsequently accessing the system would be able to view the entered comments. The third-party regulator may, for example, suggest changes to what personal data is collected in order to more fully comply with one or more legal requirements or industry standards or indicate approval of collection of a particular type of data.

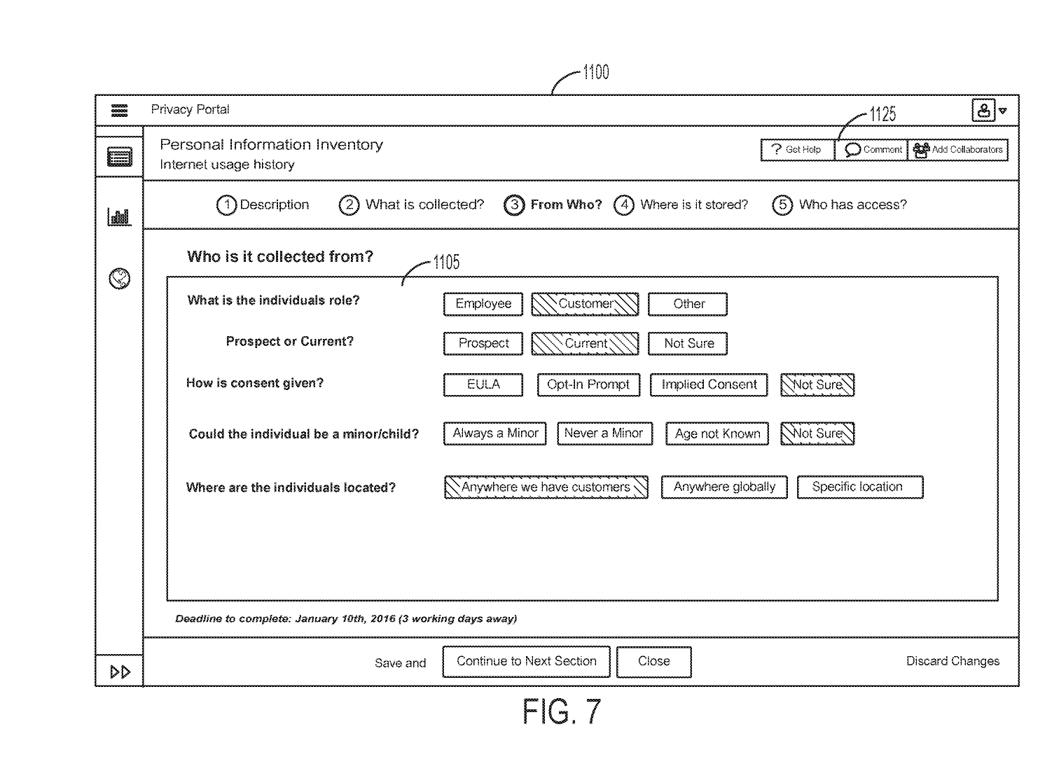

D. FIG. 7: Who Personal Data is Collected From

FIG. 7 depicts a screen display that shows who personal data is collected from in the course of the privacy campaign. As may be understood in light of this disclosure, particular privacy campaigns may collect personal data from different individuals, and guidelines may vary for privacy campaigns based on particular individuals about whom data is collected. Laws may, for example, allow an organization to collect particular personal data about their employees that they are unable to collect about customers, and so on. As with FIG. 6 described above, a screen display that different types of users of the system may experience when accessing the system may look substantially similar, however, the system's functionality may differ based on the type of user that is accessing the system (e.g., a regulator vs. an organization user). Such distinctions according to various embodiments are described below.

### i. Organization User Experience

As shown in the example of FIG. 7, the system may be configured to enable an organization user to enter and select information regarding who the personal data is gathered from as part of the privacy campaign. As noted above, the personal data may be gathered from, for example, one or more subjects. In the exemplary “Collected From” dialog 1100, an organization user may be presented with several selections in the “Who Is It Collected From” section 1105. These selections may include whether the personal data is to be collected from an employee, customer, or other entity as part of the privacy campaign. Any entities that are not stored in the system may be added by the user. The selections may also include, for example, whether the data will be collected from a current or prospective subject (e.g., a prospective employee may have filled out an employment application with his/her social security number on it). Additionally, the selections may include how consent was given, for example, through an end user license agreement (EULA), on-line Opt-in prompt, implied consent, or an indication that the user is not sure. Additional selections may include whether the personal data was collected from a minor, and/or where the subject is located.

### i. Third-Party Regulator Experience

When reviewing a privacy campaign for compliance with one or more legal or industry standards, the system may enable the third-party regulator to review who information is collected from as part of the privacy campaign using the screen displays shown in FIG. 7. As described above with respect to FIG. 6, while the third-party regulator is accessing the system in an oversight capacity, the regulator may be unable to make changes to the campaign data (e.g., by changing who data is collected about, how consent is given for the collection, etc.). The third party regulator may, however, be able to add one or more comments by selecting a comments 1125 indicia.

In response to entry of one or more comments by the regulator, the system may associate the entered comments with the personal data in memory such that an organization user subsequently accessing the system would be able to view the entered comments. The third-party regulator may, for example, suggest changes to who personal data is collect for or how consent is given for the collection in order to more fully comply with one or more legal requirements or industry standards. As a particular example, the regulator may provide a comment that Internet usage history should only be collected for users that have agreed to a EULA, and that approval of the privacy campaign will require modifying the privacy campaign to require completion of an EULA in order to collect the information.

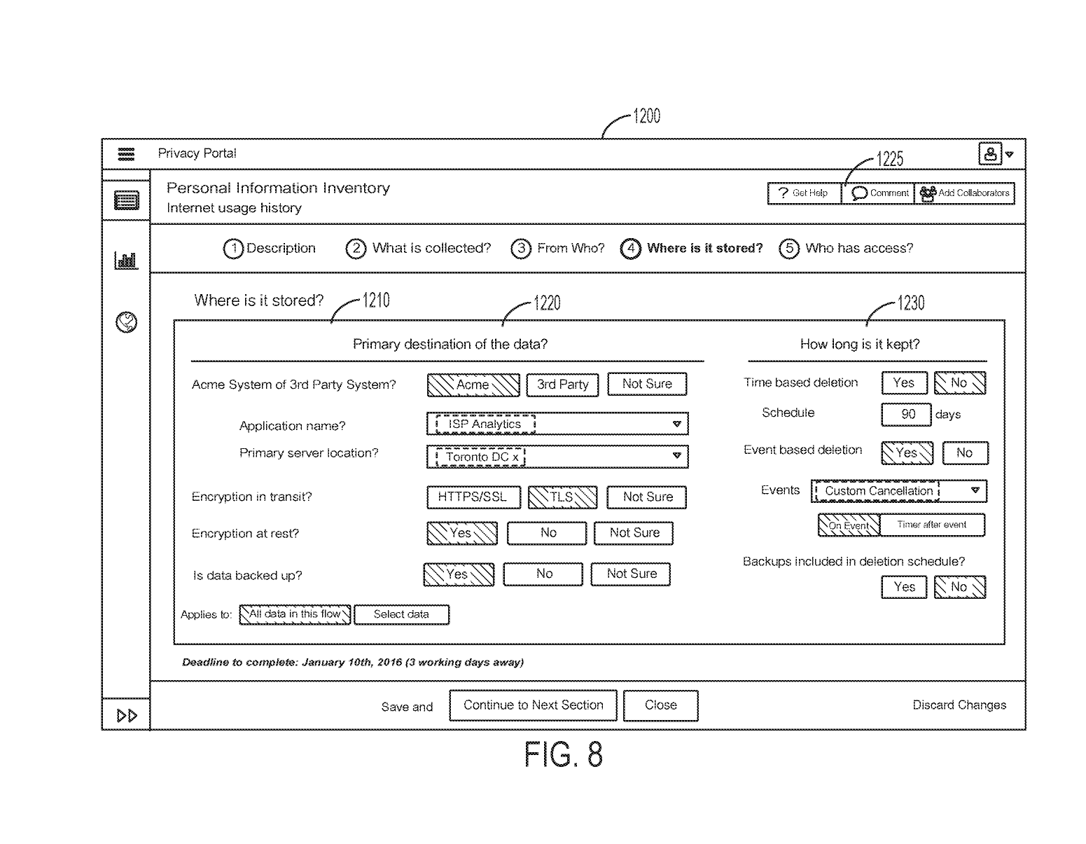

E. FIG. 8: Where is the Personal Data Stored

FIG. 8 depicts a screen display that shows where and how personal data is stored as part of the privacy campaign (e.g., on what physical server and in what location, using what encryption, etc.). As may be understood in light of this disclosure, particular privacy campaigns may collect different types of personal data, and storage guidelines may vary for privacy campaigns based on particular types of personal data collected and stored (e.g., more sensitive personal data may have higher encryption requirements, etc.). As discussed regarding FIGS. 6 and 7 above, a screen display that different types of users of the system may experience when accessing the system may look substantially similar, however, the system's functionality may differ based on a type of user that is accessing the system (e.g., a regulator vs. an organization user). Such distinctions according to various embodiments are described below.

### i. Organization User Experience

FIG. 8 depicts shows an example “Storage Entry” dialog screen 1200, which is a graphical user interface that an organization user may use to indicate where particular sensitive information is to be stored within the system as part of a particular privacy campaign. From this section, a user may specify, in this case for the Internet Usage History campaign, the primary destination of the personal data 1220 and how long the personal data is to be kept 1230. The personal data may be housed by the organization (in this example, an entity called “Acme”) or a third party. The user may specify an application associated with the personal data's storage (in this example, ISP Analytics), and may also specify the location of computing systems (e.g., one or more physical servers) that will be storing the personal data (e.g., a Toronto data center). Other selections indicate whether the data will be encrypted and/or backed up.

In various embodiments, the system also allows the user to select whether the destination settings are applicable to all the personal data of the campaign, or just select data (and if so, which data). As shown in FIG. 8, the organization user may also select and input options related to the retention of the personal data collected for the campaign (e.g., How Long Is It Kept 1230). The retention options may indicate, for example, that the campaign's personal data should be deleted after a pre-determined period of time has passed (e.g., on a particular date), or that the campaign's personal data should be deleted in accordance with the occurrence of one or more specified events (e.g., in response to the occurrence of a particular event, or after a specified period of time passes after the occurrence of a particular event), and the user may also select whether backups should be accounted for in any retention schedule. For example, the user may specify that any backups of the personal data should be deleted (or, alternatively, retained) when the primary copy of the personal data is deleted.

### i. Third-Party Regulator Experience

When reviewing a privacy campaign for compliance with one or more legal or industry standards, the system may enable the third-party regulator to review where and how information is stored as part of the privacy campaign using the screen displays shown in FIG. 8. As described above with respect to FIGS. 6 and 7, while the third-party regulator is accessing the system in an oversight capacity (e.g., is accessing a limited version of the overall privacy compliance system), the regulator may be unable to make changes to the campaign data (e.g., may be unable to alter how data is stored and for how long, etc.). The third party regulator may, however, be able to add one or more comments by selecting a comments indicia 1225.

In response to entry of one or more comments by the regulator, the system may associate the entered comments with the personal data in memory such that an organization user subsequently accessing the system would be able to view the entered comments. The third-party regulator may, for example, submit comments that a period of time for which particular type of data is going to be kept exceeds a particular industry practice. As discussed above, the system may modify the campaign data to include the comment and associate the comment with storage location data for the privacy campaign for later review.

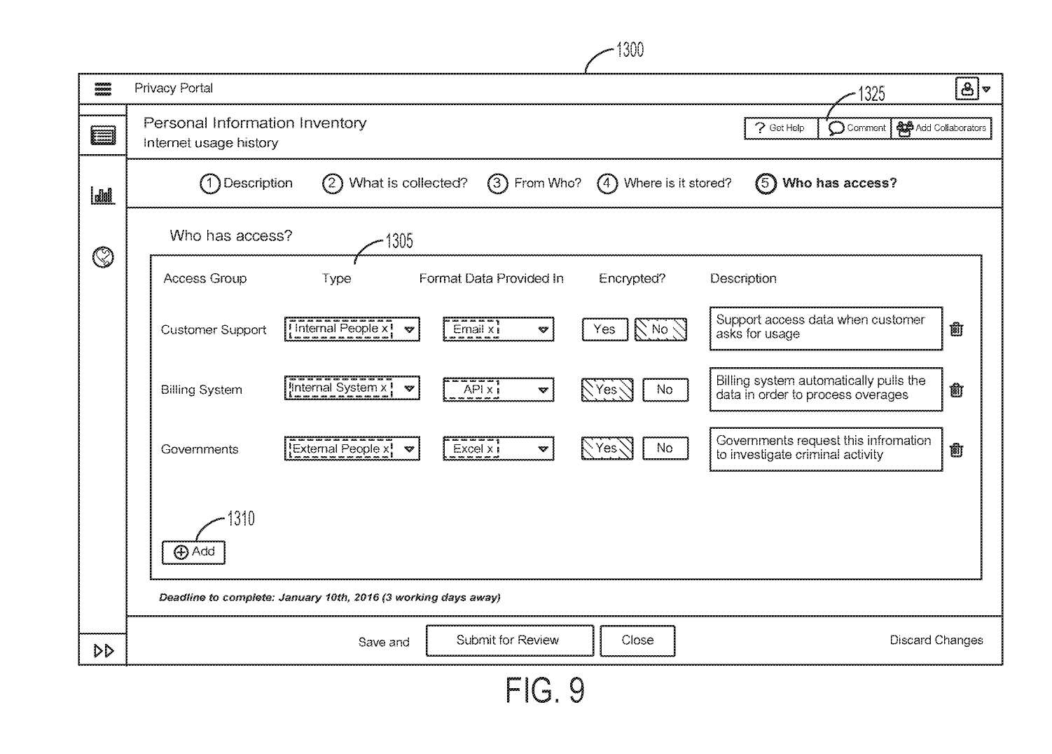

F. FIG. 9: Who and What Systems Have Access to Personal Data

FIG. 9 depicts an exemplary screen display that shows who and what systems have access to personal data that is stored as part of the privacy campaign (e.g., what individuals, business groups, etc. have access to the personal data.). As may be understood in light of this disclosure, particular privacy campaigns may require different individuals, groups, or systems within an organization to access personal data to use it for the purpose for which it was collected (e.g., to run payroll, billing purposes, etc.). As discussed above with respect to FIGS. 6, 7, and 8 above, a screen display that different types of users of the system may experience when accessing the system may look substantially similar, however, the system's functionality may differ based on a type of user that is accessing the system (e.g., a regulator vs. an organization user). Such distinctions according to various embodiments are described below.

### i. Organization User Experience

FIG. 9 depicts an example Access entry dialog screen 1300 which an organization user may use to input various access groups that have permission to access particular personal data that makes up part of the privacy campaign. As part of the process of adding a campaign or data flow, the user may specify particular access groups in the “Who Has Access” section 1305 of the dialog screen 1300. In the example shown, the Customer Support, Billing, and Governments groups within the organization may be able to access the Internet Usage History personal data collected by the organization as part of the privacy campaign. Within each of these access groups, the user may select the type of each group, the format in which the personal data may be provided, and whether the personal data is encrypted. The access level of each group may also be entered. The user may add additional access groups via the Add Group button 1310.

### i. Third-Party Regulator Experience

When reviewing a privacy campaign for compliance with one or more legal or industry standards, the system may enable the third-party regulator to review who has access to particular personal data using the screen displays shown in FIG. 9. As described above with respect to FIGS. 6, 7, and 8, while the third-party regulator is accessing the system in an oversight capacity (e.g., is accessing a limited version of the overall privacy compliance system), the regulator may be unable to make changes to the campaign data (e.g., may be unable to add additional access groups or remove existing ones). The third party regulator may, however, be able to add one or more comments by selecting a comments indicia 1325.

In response to entry of one or more comments by the regulator, the system may associate the entered comments with the personal data in memory such that an organization user subsequently accessing the system would be able to view the entered comments (e.g., either directly on user-interface such as the screen display shown in the embodiment of FIG. 9, or in any other suitable manner). As discussed above, the system may modify the campaign data to include the comment and associate the comment with access data for the privacy campaign for later review.

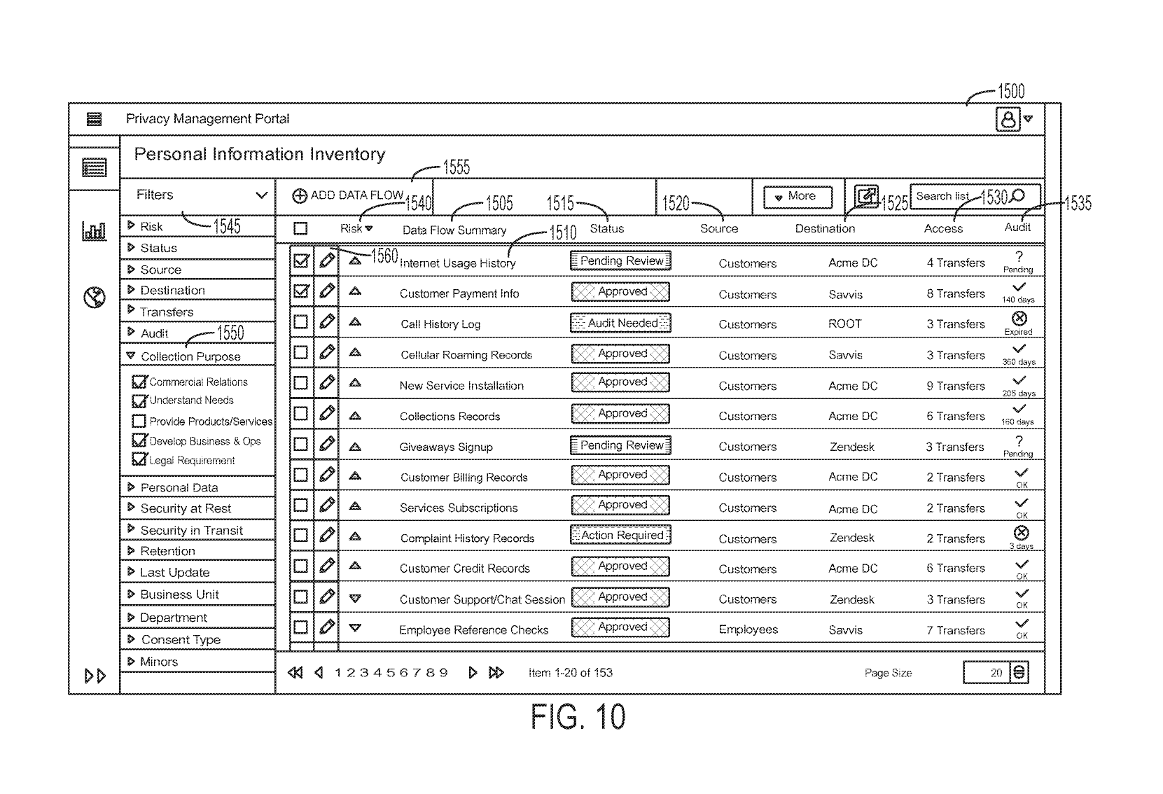

H: FIG. 10: Campaign Inventory Page

After new campaigns have been added, for example using the exemplary processes explained in regard to FIGS. 4-9, the users of the system may view their respective campaign or campaigns, depending on whether they have access to the campaign and the type of access to the system they have. The chief privacy officer, or another privacy office representative, for example, may be the only user that may view all campaigns. A regulator may be limited to viewing only those campaigns that they have been tasked to review. A listing of all of the campaigns within the system may be viewed on, for example, inventory page 1500 (see below).

FIG. 10 depicts an example embodiment of an inventory page 1500 that may be generated by the system. The inventory page 1500 may be represented in a graphical user interface. Each of the graphical user interfaces (e.g., webpages, dialog boxes, etc.) presented in this application may be, in various embodiments, an HTML-based page capable of being displayed on a web browser (e.g., Firefox, Internet Explorer, Google Chrome, Opera, etc.), or any other computer-generated graphical user interface operable to display information, including information having interactive elements (e.g., an iOS, Mac OS, Android, Linux, or Microsoft Windows application). The webpage displaying the inventory page 1500 may include typical features such as a scroll-bar, menu items, as well as buttons for minimizing, maximizing, and closing the webpage. The inventory page 1500 may be accessible to the organization's chief privacy officer, or any other of the organization's personnel having the need, and/or permission, to view personal data.

Still referring to FIG. 10, inventory page 1500 may display one or more campaigns listed in the column heading Data Flow Summary 1505, as well as other information associated with each campaign, as described herein. Some of the exemplary listed campaigns include Internet Usage History 1510 (e.g., described above with respect to FIGS. 4-9), Customer Payment Information, Call History Log, Cellular Roaming Records, etc. A campaign may represent, for example, a business operation that the organization is engaged in and may require the use of personal data, which may include the personal data of a customer. In the campaign Internet Usage History 1510, for example, a marketing department may need customers' on-line browsing patterns to run certain types of analytics.

The inventory page 1500 may also display the status of each campaign, as indicated in column heading Status 1515. Exemplary statuses may include “Pending Review”, which means the campaign has not been approved yet, “Approved,” meaning the personal data associated with that campaign has been approved, “Audit Needed,” which may indicate that a privacy audit of the personal data associated with the campaign is needed, and “Action Required,” meaning that one or more individuals associated with the campaign must take some kind of action related to the campaign (e.g., completing missing information, responding to an outstanding message, etc.). In certain embodiments, the approval status of the various campaigns relates to approval by one or more third-party regulators as described herein.

The inventory page 1500 of FIG. 10 may list the “source” from which the personal data associated with a campaign originated, under the column heading “Source” 1520. As an example, the campaign “Internet Usage History” 1510 may include a customer's IP address or MAC address. For the example campaign “Employee Reference Checks”, the source may be a particular employee.

The inventory page 1500 of FIG. 10 may also list the “destination” of the personal data associated with a particular campaign under the column heading Destination 1525. Personal data may be stored in any of a variety of places, for example, on one or more databases 140 that are maintained by a particular entity at a particular location. Different custodians may maintain one or more of the different storage devices. By way of example, referring to FIG. 10, the personal data associated with the Internet Usage History campaign 1510 may be stored in a repository located at the Toronto data center, and the repository may be controlled by the organization (e.g., Acme corporation) or another entity, such as a vendor of the organization that has been hired by the organization to analyze the customer's internet usage history. Alternatively, storage may be with a department within the organization (e.g., its marketing department).

On the inventory page 1500, the Access heading 1530 may show the number of transfers that the personal data associated with a campaign has undergone. This may, for example, indicate how many times the data has been accessed by one or more authorized individuals or systems.

The column with the heading Audit 1535 shows the status of any privacy audits associated with the campaign. Privacy audits may be pending, in which an audit has been initiated but yet to be completed. The audit column may also show for the associated campaign how many days have passed since a privacy audit was last conducted for that campaign. (e.g., 140 days, 360 days). If no audit for a campaign is currently required, an “OK” or some other type of indication of compliance (e.g., a “thumbs up” indicia) may be displayed for that campaign's audit status. The audit status, in various embodiments, may refer to whether the privacy campaign has been audited by a third-party regulator or other regulator as required by law or industry practice or guidelines.

The example inventory page 1500 may comprise a filter tool, indicated by Filters 1545, to display only the campaigns having certain information associated with them. For example, as shown in FIG. 10, under Collection Purpose 1550, checking the boxes “Commercial Relations,” “Provide Products/Services”, “Understand Needs,” “Develop Business & Ops,” and “Legal Requirement” will result the display under the Data Flow Summary 1505 of only the campaigns that meet those selected collection purpose requirements.

From example inventory page 1500, a user may also add a campaign by selecting (i.e., clicking on) Add Data Flow 1555. Once this selection has been made, the system initiates a routine (e.g., a wizard) to guide the user in a phase-by-phase manner through the process of creating a new campaign An example of the multi-phase GUIs in which campaign data associated with the added privacy campaign may be input and associated with the privacy campaign record is described in FIGS. 4-9 above.

From the example inventory page 1500, a user may view the information associated with each campaign in more depth, or edit the information associated with each campaign. To do this, the user may, for example, click on or select the name of the campaign (i.e., click on Internet Usage History 1510). As another example, the user may select a button displayed on the screen indicating that the campaign data is editable (e.g., edit button 1560).

### Alternative Embodiments

Various embodiments of the privacy compliance oversight systems described herein may include features in addition to those described above. Exemplary alternative embodiments are described below.

Automatic Implementation of Approved Privacy Campaign, Project, or Other Activity

In embodiments in which a privacy campaign (e.g., or project or other activity) requires third-party approval prior to implementation, the system may be configured to substantially automatically implement the privacy campaign in response to approval by a third-party regulator. For example, in response to a particular third-party regulator approving a proposed privacy campaign as complying with one or more legal standards related to personal data storage location, the system may be configured to automatically initiate the privacy campaign by beginning to collect the personal data and storing it in the proposed storage location.

Automatic Modification of Privacy Campaign in Response to Indication of Excessive Data Handling Precautions by Third-Party Regulator

In particular embodiments, such as those described above, a third party regulator may provide one or more pieces of feedback indicating that one or more aspects of a privacy campaign exceed a particular legal standard or industry standard for personal data handling. For example, a privacy campaign may indicate that users' e-mail addresses will be stored using 256 bit encryption when industry standards only require 128 bit encryption. In such embodiments, the system may be configured to substantially automatically modify the privacy campaign to meet but not exceed any legal or industry standard in order to conserve computing resources associated with the storage of the personal data.

Automatic Modification of Privacy Campaign in Response to Third-Party Regulator Feedback

In various embodiments, the system may be configured to substantially automatically modify a privacy campaign in response to the one or more pieces of feedback from the third-party regulator. For example, where a third-party regulator is analyzing computer code for compliance with one or more legal or industry guidelines, the computer code may include privacy-related attributes indicating one or more types of personal information that the computer code collects or accesses. In response to the third-party regulator providing feedback that the computer code, when executed, improperly stores collected data, the system may be configured to substantially automatically modify the computer code to store the collected data in a legally-mandated location, or in a legally-mandated manner.

In such embodiments, for example, the system may automatically modify the computer code to adjust one or more permissions associated with the stored personal information to modify which individuals associated with a particular organization may be legally entitled to access the personal information. In another particular example, where the computer code, when executed, causes the system to store the collected information on a first server that the third-party regulator indicates does not meet one or more legal requirements for personal data storage, the system may be configured to: (1) automatically determine a second server that does meet the one or more legal requirements; and (2) modify the computer code such that, when executed, the computer code causes the system to store the collected personal data on the second server.

### Conclusion

Although embodiments above are described in reference to various privacy compliance oversight systems, it should be understood that various aspects of the system described above may be applicable to other privacy-related systems, or to other types of systems, in general.

While this specification contains many specific embodiment details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Many modifications and other embodiments of the invention will come to mind to one skilled in the art to which this invention pertains having the benefit of the teachings presented in the foregoing descriptions and the associated drawings. While examples discussed above cover the use of various embodiments in the context of operationalizing privacy compliance and assessing risk of privacy campaigns, various embodiments may be used in any other suitable context. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A computer-implemented data processing method for facilitating third-party regulatory oversight of a privacy compliance system associated with an organization, the method comprising:
flagging, by one or more processors, a particular project undertaken by the organization that includes the use of personal data for review, wherein:
the privacy compliance system digitally stores an electronic record associated with the particular project, the electronic record comprising:
one or more types of personal data collected as part of the project;
a subject from which the personal data was collected;
a storage location of the personal data; and
one or more access permissions associated with the personal data;
in response to flagging the particular project, preparing, by one or more processors, the electronic record for review by a third-party regulator;
providing, by one or more processors, the third-party regulator with access to the electronic record;
receiving, from the third-party regulator, by one or more processors, one or more pieces of feedback associated with the project; and
in response to receiving the one or more pieces of feedback, modifying, by one or more processors, the electronic record to include the one or more pieces of feedback.

2. The computer-implemented data processing method of claim 1, the method further comprising:
receiving, by one or more processors, a request for review of the project from an individual associated with the organization; and
the step of flagging the particular project undertaken by the organization that includes the use of personal data in response to the request.

3. The computer-implemented data processing method of claim 1, the method further comprising:
the step of automatically flagging the particular project undertaken by the organization for review, by one or more processors, based at least in part on at least one aspect of the electronic record selected from the group consisting of:
one or more types of personal data related to the project;
a subject from which the personal data was collected;
a storage location of the personal data; and
one or more access permissions associated with the personal data.

4. The computer-implemented data processing method of claim 1, the method further comprising automatically flagging the particular project undertaken by the organization for review, by one or more processors, in response to initiation of the project by the organization and creation of the electronic record.

5. The computer-implemented data processing method of claim 1, wherein preparing the electronic record for review by the third-party regulator comprises using one or more machine translation techniques on at least a portion of the electronic record to translate the personal data from a first human language to a second human language.

6. The computer-implemented data processing method of claim 1, wherein providing the third-party regulator with access to the electronic record comprises providing access to the third-party regulator, via one or more graphical user interfaces, to at least a portion of the privacy compliance system, the at least a portion of the privacy compliance system comprising the electronic record.

7. The computer-implemented data processing method of claim 6, wherein providing the third-party regulator with access to the electronic record comprises:
generating a secure link between the electronic record and a computing device associated with the third-party regulator; and
providing access, to the third-party regulator via the secure link, to the electronic record.

8. The computer-implemented data processing method of claim 7, wherein:
the one or more pieces of feedback comprise approval of the storage location of the personal data; and
the method further comprises:
modifying the electronic record to include the approval; and
implementing the project by collecting one or more pieces of personal data and storing the one or more pieces of personal data in the storage location.

9. The computer-implemented data processing method of claim 1, wherein preparing the electronic record for review by a third-party regulator comprises modifying and exporting the electronic record into a standardized format.

10. A computer-implemented data processing method for electronically facilitating third-party regulation of a privacy campaign, the method comprising:
displaying, on a graphical user interface, a prompt to create an electronic record for a privacy campaign;
receiving a command to create an electronic record for the privacy campaign;
creating an electronic record for the privacy campaign comprising campaign data and digitally storing the record in memory, the campaign data comprising:
a description of the campaign;
one or more types of personal data related to the campaign;
a subject from which the personal data was collected;
a storage location of the personal data; and
one or more access permissions associated with the personal data;
processing the campaign data by electronically associating the campaign data with the record for the privacy campaign;
digitally storing the campaign data associated with the record for the campaign;
identifying, by one or more processors, one or more pieces of campaign data that require third-party regulator approval;
exporting, by a processor, the identified one or more pieces of campaign data for review by the third-party regulator;
displaying, on a graphical user interface, the one or more pieces of campaign data to the third-party regulator and a prompt to provide feedback regarding the one or more pieces of campaign data;
receiving, from the third-party regulator, via the graphical user interface, feedback regarding the one or more pieces of campaign data; and
modifying the electronic record for the privacy campaign to include the feedback.

11. The computer-implemented data processing method of claim 10, wherein exporting the identified one or more pieces of campaign data for review by the third-party regulator comprises exporting the identified one or more pieces of campaign data into a standardized format and transmitting the identified one or more pieces of campaign data to a computing device associated with the third party-regulator via one or more computer networks.

12. The computer-implemented data processing method of claim 10, wherein exporting the identified one or more pieces of campaign data for review by the third-party regulator comprises:
generating a secure link between the electronic record for the privacy campaign and a computing device associated with the third-party regulator; and
providing access, to the third-party regulator via the secure link, to at least a portion of the electronic record for the privacy campaign, the at least a portion of the electronic record for the privacy campaign comprising the identified one or more pieces of campaign data for review.

13. The computer-implemented data processing method of claim 10, further comprising:
generating a log of actions taken by the third-party regulator while accessing the at least a portion of the electronic record for the privacy campaign via the secure link; and
associating, in memory, the log with the electronic record for the privacy campaign.

14. The computer-implemented data processing method of claim 10, wherein:
identifying the one or more pieces of campaign data that require third-party regulator approval comprises receiving a request from a user for the third-party regulator to review the one or more pieces of campaign data.

15. A computer-implemented data processing method for electronically performing third-party oversight of one or more privacy assessments of computer code, the method comprising:
flagging the computer code for third-party oversight, the computer code being stored in a location;
electronically obtaining the computer code based on the location provided;
automatically electronically analyzing the computer code to determine one or more privacy-related attributes of the computer code, each of the privacy-related attributes indicating one or more types of personal information that the computer code collects or accesses;
generating a list of the one or more privacy-related attributes;
transmitting the list of the one or more privacy-related attributes to a computing device associated with a third-party regulator;
electronically displaying one or more prompts to the third-party regulator, each prompt informing the third-party regulator to input information regarding one or more of the one or more privacy-related attributes; and
communicating the information regarding the one or more privacy-related attributes to one or more second individuals for use in conducting a privacy assessment of the computer code.

16. The computer-implemented data processing method of claim 15, the method further comprising using one or more machine translation techniques to translate the list of the one or more privacy-related attributes from a first language to a second language.

17. The computer-implemented data processing method of claim 15, wherein transmitting the list of the one or more privacy-related attributes to a computing device associated with a third-party regulator comprises transmitting the list of the one or more privacy-related attributes via a secure link.

18. The computer-implemented data processing method of claim 15, further comprising automatically modifying the computer code based at least in part on the information regarding the one or more of the one or more privacy-related attributes.

19. The computer-implemented data processing method of claim 15, further comprising:
receiving, by one or more processors, a request for third-party oversight of the computer code; and
flagging the computer code for third-party oversight in response to the request.

20. The computer-implemented data processing method of claim 19, wherein:
the computer code is associated with an organization;
the request is an expedited request; and
the method further comprises reducing a number of expedited requests available to the organization in response to the expedited request.
